(19) United States
(12) Patent Application Publication
(10) Pub. No.: US 2024/0261796 A1
(43) Pub. Date: Aug. 8, 2024

(54) WEARABLE AIR PURIFIER

(71) Applicant: Shu-Hsien CHOU, New Taipei City (TW)

(72) Inventor: Shu-Hsien CHOU, New Taipei City (TW)

(21) Appl. No.: 18/179,715

(22) Filed: Mar. 7, 2023

(30) Foreign Application Priority Data
Feb. 7, 2023 (CN) 202320143229.5

(51) Int. Cl. B03C 3/32; B03C 3/82

(52) U.S. Cl. CPC B03C 3/32; B03C 3/82

(57) ABSTRACT

A wearable air purifier having: a shell having an electrical connecting part on an inner surface thereof and the electrical connecting part being electrically connected to an outer surface conductive area of the shell; a circuit board provided inside the shell and having a grounding layer electrically coupled to the electrical connecting part via a grounding structure; and a wearable member connected to the shell for a user to wear to carry the wearable air purifier on the user.

### BACKGROUND OF THE INVENTION

### Field of the Invention

This invention is related to a wearable air purifier, especially to a wearable air purifier that can release static electricity through the contact between a conductive shell and the user's body.

### Description of the Related Art

Please refer to FIG. 1 and FIG. 2, where FIG. 1 illustrates an exploded view of a conventional wearable air purifier; and FIG. 2 illustrates an assembled view of the wearable air purifier of FIG. 1 without a top shell.

As shown in FIG. 1, the wearable air purifier has a top shell 11, a bottom shell 12, a circuit board 13, a lanyard 14, a first screw 15 and a second screw 16.

The circuit board 13 is fastened to a first projection 12a of the bottom shell 12 by a first screw 15 through a perforated hole 13a; the lanyard 14 is fastened to a second projection 12b of the bottom shell 12 by a second screw 15 screwing through a pair of overlapping metal rings 14a provided at two free ends of the lanyard 14; and the lanyard 14 is a conductive lanyard. When the user uses the lanyard 14 to hang the wearable air purifier on the body, because the ground layer of the circuit board 13 is electrically coupled with the lanyard 14 through the second projection 12b, and the lanyard 14 can conduct electricity, so the static electricity on the circuit board 13 can be released to earth via the lanyard 14 and the user's body in contact with the lanyard 14.

However, the wearable air purifier still has some problems. For example, when the lanyard 14 is accidently pulled, the metal ring 14a can easily get detached. Besides, the contact area between the rope surface and the body is small.

To solve the problems mentioned above, there is an urgent need for a new type of wearable air purifier in the field.

### SUMMARY OF THE INVENTION

The main objective of the invention is to disclose a wearable air purifier that can effectively discharge static electricity through the contact between a conductive shell and the user's body.

Another objective of the invention is to disclose a wearable air purifier that can provide a more reliable electrostatic release mechanism.

To attain the foregoing objectives, a wearable air purifier is proposed, the wearable air purifier including:
a shell having an electrical connecting part on an inner surface thereof and the electrical connecting part being electrically connected to an outer surface conductive area of the shell;
a circuit board provided inside the shell and having a grounding layer electrically coupled to the electrical connecting part via a grounding structure; and
a wearable member connected to the shell for a user to wear to carry the wearable air purifier on the user.

In one embodiment, the outer surface conductive area is an outer surface area of a bottom shell of the shell, and the outer surface area is doped with a metal material.

In one embodiment, the outer surface conductive area is an outer surface area of a bottom shell of the shell, and the outer surface area is coated with a metallic material.

In one embodiment, the outer surface conductive area is an outer surface area of a bottom shell of the shell, and the outer surface area is doped with graphite.

In one embodiment, the outer surface conductive area is an outer surface area of a top shell of the shell, and the outer surface area is doped with a metallic material.

In one embodiment, the outer surface conductive area is an outer surface area of a top shell of the shell, and the outer surface area is coated with a metallic material.

In one embodiment, the outer surface conductive area is an outer surface area of a top shell of the shell, and the outer surface area is doped with graphite.

In one embodiment, the grounding structure contains a metal screw, a metal bolt or a metal rivet.

In one embodiment, the wearable member is a lanyard.

In one embodiment, the wearable member is a clip.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 shows an exploded view of a conventional wearable air purifier.

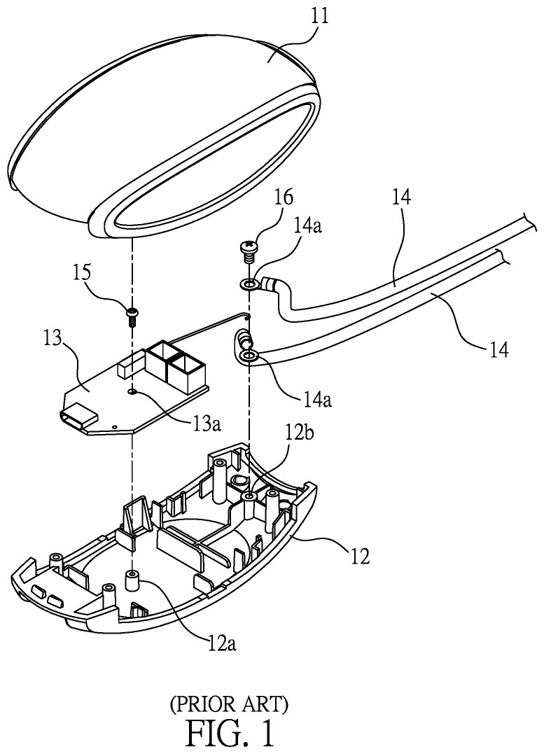

FIG. 2 shows the assembled diagram of the wearable air purifier in FIG. 1 without a top shell.

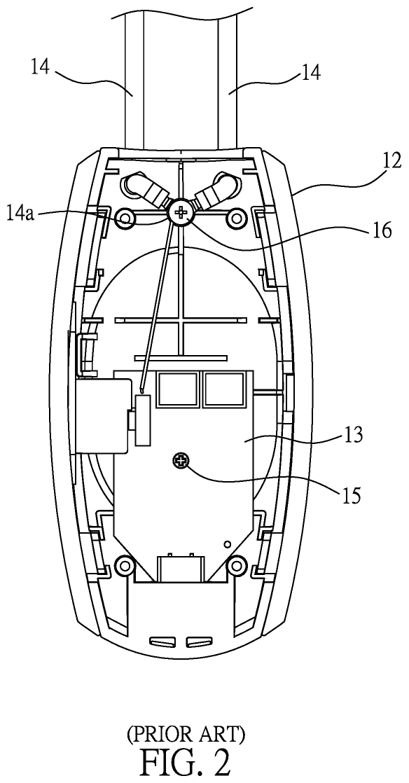

FIG. 3 shows an exploded view of the wearable air purifier of the present invention.

FIG. 4 shows an assembled view of the wearable air purifier in FIG. 3 without a top shell.

FIG. 5 is a schematic view showing the appearance of another embodiment of the wearable air purifier of the present invention.

### DETAILED DESCRIPTION OF THE PREFERRED EMBODIMENTS

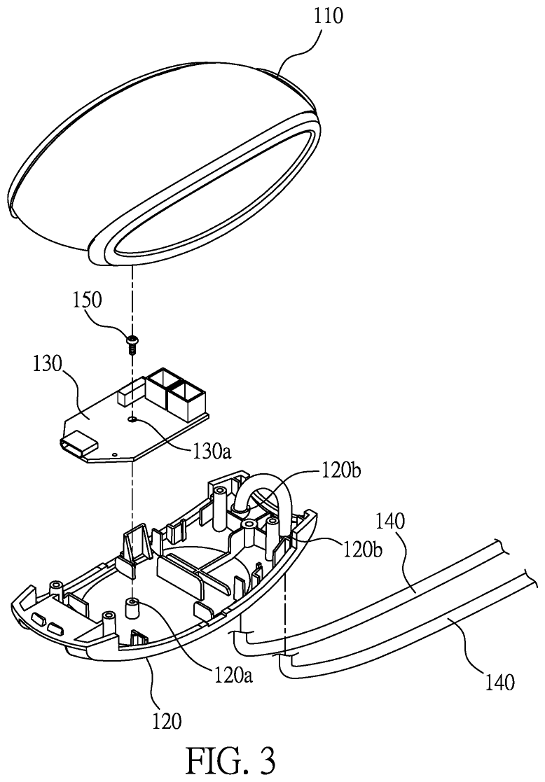

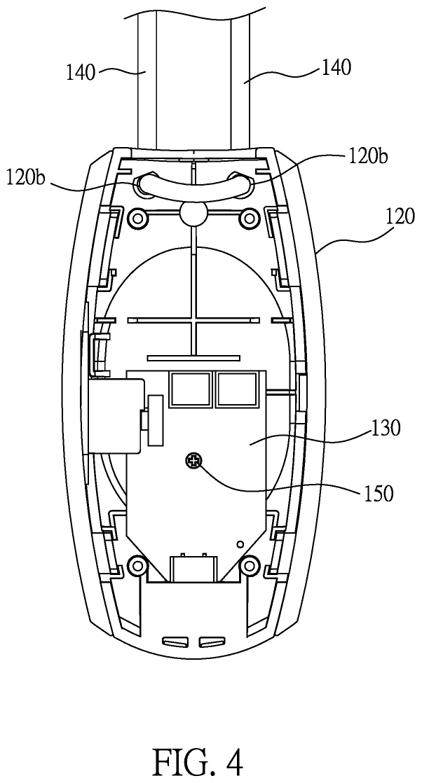

Please refer to FIG. 3 and FIG. 4, where shows an exploded view of the wearable air purifier of the present invention; and FIG. 4 shows an assembled view of the wearable air purifier in FIG. 3 without a top shell.

As shown in FIG. 3, the wearable air purifier has a top shell 110, a bottom shell 120, a circuit board 130, a lanyard 140, and a grounding structure 150.

The circuit board 130 is locked to an electrical connecting part 120a of the bottom shell 120 by the grounding structure 150 through a perforation 130a; the lanyard 140 is passed through two lanyard perforations 120b of the bottom shell 120; and the lanyard 140 is an insulated or non-conductive lanyard.

When a user uses the lanyard 140 to hang the wearable air purifier on the body, since the grounding layer of the circuit board 130 is electrically coupled to the bottom shell 120 through the grounding structure 150, and the bottom shell 120 can conduct electricity, the static electricity on the circuit board 130 can be released to earth via the bottom shell 120 and the user's body in contact with the bottom shell 120.

For possible embodiments, the bottom shell 120 can be doped or coated with a metallic material, or doped with graphite.

Alternatively, the top shell 110 can be a conductive shell, and it may be doped or coated with a metallic material, or doped with graphite.

Alternatively, the grounding structure 150 can include a metal screw, a metal bolt, or a metal rivet.

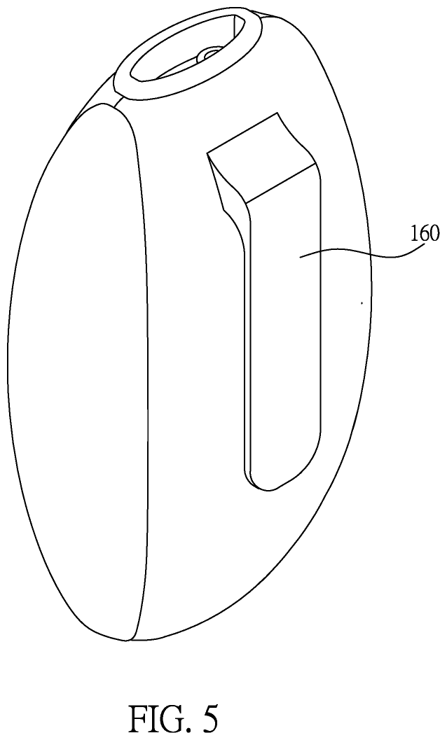

In addition, the wearable air purifier of the present invention can be fixed to the user via a clip. Please refer to FIG. 5, which illustrates a schematic view showing the appearance of another embodiment of the wearable air purifier of the present invention. As shown in FIG. 5, the wearable air purifier has a clip 160 attached to its shell for the user to fix the wearable air purifier to the body. In light of the above description, it can be seen that the present creation discloses a wearable air purifier, which includes: a shell having an electrical connecting part on an inner surface thereof and the electrical connecting part being electrically connected to an outer surface conductive area of the shell; a circuit board provided inside the shell and having a grounding layer electrically coupled to the electrical connecting part via a grounding structure; and a wearable member connected to the shell for a user to wear to carry the wearable air purifier on the user.

In the wearable air purifier, the outer surface conductive area can be an outer surface area of a bottom shell of the shell, and the outer surface area can be doped or coated with a metallic material, or doped with graphite. Alternatively, the outer surface conductive area can be an outer surface area of a top shell of the shell, and the outer surface area can be doped or coated with a metallic material, or doped with graphite. Alternatively, the outer surface conductive area can be the entire outer surface of the shell, and the entire outer surface can be doped or coated with a metallic material, or doped with graphite.

In addition, the grounding structure can include a metal screw, a metal bolt, or a metal rivet.

In addition, the wearable member can be a lanyard or a clip.

With the designs disclosed above, the invention has the following advantages:
1. The wearable air purifier of the invention can effectively discharge static electricity through the contact between a conductive shell and the user's body.

2. The wearable air purifier of the invention can provide a more reliable electrostatic release mechanism.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A wearable air purifier comprising:
a shell having an electrical connecting part on an inner surface thereof and the electrical connecting part being electrically connected to an outer surface conductive area of the shell;
a circuit board provided inside the shell and having a grounding layer electrically coupled to the electrical connecting part via a grounding structure; and
a wearable member connected to the shell for a user to wear to carry the wearable air purifier on the user.

2. The wearable air purifier as disclosed in claim 1, wherein the outer surface conductive area is an outer surface area of a bottom shell of the shell, and the outer surface area is doped with a metal material.

3. The wearable air purifier as disclosed in claim 1, wherein the outer surface conductive area is an outer surface area of a bottom shell of the shell, and the outer surface area is coated with a metallic material.

4. The wearable air purifier as disclosed in claim 1, wherein the outer surface conductive area is an outer surface area of a bottom shell of the shell, and the outer surface area is doped with graphite.

5. The wearable air purifier as disclosed in claim 1, wherein the outer surface conductive area is an outer surface area of a top shell of the shell, and the outer surface area is doped with a metallic material.

6. The wearable air purifier as disclosed in claim 1, wherein the outer surface conductive area is an outer surface area of a top shell of the shell, and the outer surface area is coated with a metallic material.

7. The wearable air purifier as disclosed in claim 1, wherein the outer surface conductive area is an outer surface area of a top shell of the shell, and the outer surface area is doped with graphite.

8. The wearable air purifier as disclosed in claim 1, wherein the grounding structure contains a metal screw, a metal bolt or a metal rivet.

9. The wearable air purifier as disclosed in claim 1, wherein the wearable member is a lanyard.

10. The wearable air purifier as disclosed in claim 1, wherein the wearable member is a clip.
